(19) United States
(12) Patent Application Publication
(10) Pub. No.: US 2025/0358034 A1
(43) Pub. Date: Nov. 20, 2025

(54) TIME-MULTIPLEXED OPTICAL LINK WITH DELAY

(71) Applicant: Microsoft Technology Licensing, LLC, Redmond, WA (US)

(72) Inventors: Vasily LYUTSAREV, Cambridge (GB); Kai SHI, Cambridge (GB); Charles BOECKER, Ames, IA (US); Daniel Jonathan Finchley CLETHEROE, Cambridge (GB); Kaoutar BENYAHYA, Cambridge (GB); Junyi LIU, Cambridge (GB); Ariel GOMEZ DIAZ, Cambridge (GB); Shawn Yohanes SIEW, Cambridge (GB); Paolo COSTA, London (GB)

(21) Appl. No.: 18/946,915

(22) Filed: Nov. 13, 2024

Related U.S. Application Data
(60) Provisional application No. 63/649,940, filed on May 20, 2024.

(51) Int. Cl. H04J 3/16; H04J 3/06

(52) U.S. Cl. CPC H04J 3/1652; H04J 3/0635

(57) ABSTRACT

An apparatus for receiving data, wherein the apparatus is configured to: receive a multiplexed data stream over an optical link, the multiplexed data stream comprising: a first data stream sent from a first transmitter, the first data stream having a minimum time interval between condition changes; a second data stream sent from a second transmitter, the second data stream having the same minimum time interval between condition changes, wherein the second data stream is delayed by a fraction of the minimum time interval relative to the first data stream.

### BACKGROUND

An optical transmission system typically comprises at least: (a) a transmitter; (b) an optical medium; and (c) a receiver. Each of these elements can impose a bandwidth limitation, limiting the maximum data rate that can be transmitted. In many optical systems, it is the transmitter which has the lowest bandwidth. This means that often the optical medium and the receiver supports a higher data rate, but the data rate cap is imposed by the transmitter. The number of optical mediums (for example fiber cores) may also be limited, which also encourages us to increase the data rate going through each optical medium.

Given that often the transmitter is the limitation, in principle multiple transmitters could be multiplexed into a single optical medium. There are ways to then split the data stream at the receiver end (such as dual-polarization systems, IQ modulation) or to have multi-level detection (Pulse Amplitude Modulation 4-level (PAM-4) for 4 amplitude levels, PAM-8 for 8 amplitude levels). However, for non-coherent systems, it is generally difficult to split a multiplexed signal. For direct detection systems, multi-level systems impose a large signal-to-noise ratio penalty (9.5 dB for PAM-4 and 17 dB for PAM-8). Optical Time Division Multiple Access (TDMA) systems can also share a single optical medium and receiver for multiple transmitters, but this requires the transmitter to have the same data rate as the total system data rate.

### Summary

According to one aspect disclosed herein, there is provided a method of data transmission comprising: sending, to a receiver and over an optical link, a first data stream having a minimum time interval between condition changes; sending, to the receiver and over the optical link, a second data stream having the same minimum time interval between condition changes, wherein the second data stream is delayed by a fraction of the minimum time interval relative to the first data stream.

According to further aspects disclosed herein, there are provided a corresponding program and a corresponding apparatus, configured to perform operations corresponding to any embodiment of the methods described herein. According to yet further aspects there are provided corresponding receive-side methods, programs and receiver apparatus.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic diagram showing data streams sent over an optical link;

FIG. 2A is a schematic diagram showing how the data streams of FIG. 1 can be decoded, in an example where there are two channels;

FIG. 2B is a schematic diagram showing how the data streams of FIG. 1 can be decoded, in an example where there are three channels;

FIG. 3 is an expected eye diagram of Channel A +Channel B in FIG. 2A;

FIG. 4 shows a schematic diagram for clocked rising edge and falling edge data decoding;

FIG. 5 shows a circuit diagram for clocked rising edge and falling edge data decoding;

FIG. 6 is a flow chart describing a method disclosed herein;

FIG. 7 is a flow chart describing a method disclosed herein.

### DETAILED DESCRIPTION OF EMBODIMENTS

Some examples described herein provide a method for transmitting and receiving multiplexed steams of data over an optical link, wherein the data streams are offset by a delay. The delay can be used to decode the multiplexed streams at the receiver side.

A time-multiplexed optical link is provided, where there are N transmitters, where N is an integer equal to two or more. Each transmitter is delayed by a fraction of at least the unit interval (UI), the fraction being UI/N. This provides a bitwise interleaved time multiplexed format. A UI may be considered to be a minimum time interval for a data stream in between condition changes of the data stream. The UI may comprise a pulse time and/or a symbol duration time. The UI may be equal to the time taken in a data stream by each subsequent pulse (or symbol).

According to examples described herein, coherency does not need to be utilized, and one receiver can receive the multiplexed light from all of the transmitters. N clocked rising edge detectors and N falling edge detectors can be used, with the trigger signal separated by the fractional unit interval delay (UI/N) on each of the paired detectors. In some examples, a trigger signal may comprise a first signal received from a particular transmitter. At the receiver side, there can be N decoders. There may be a decoder corresponding to each transmitter. Each decoder may comprise a rising edge detector and a falling edge detector. This allows the data stream to be recreated from each of the transmitters. Each decoder can decode a data stream of a respective transmitter.

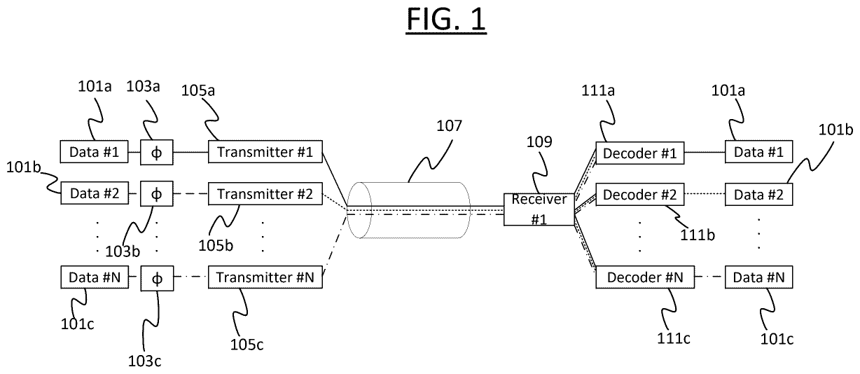

FIG. 1 shows an example system showing multiplexing and subsequent decoding of the data. There are N data streams. Data #1 101a is sent over a first data stream (shown as a solid line in FIG. 1) by transmitter 105a, with a delay 103a. Data #2 101b is sent over a second data stream (shown as a dashed line in FIG. 1) by transmitter 105b, with a delay 103b. Data #N 101c is sent over a third data stream (shown in as a dash-dot line in FIG. 1) by transmitter 105c, with a delay 103c. Each of delays 103a, 103b and 103c may be offset from one another by a multiple of UI/N.

The multiplexed data streams cross an optical link 107 (e.g., an optical medium) to receiver 109. Receiver 109 can use information of the offset of each data stream to decode the multiplexed data streams using decoders 111a, 111b, 111c and provide decoded data 101a, 101b, 101c at the receiver side. As a result, compared to a TDMA system, where if the total bitrate is X, each transmitter and receiver needs to be capable of a bit rate of X, in the method of FIG. 1 each transmitter only requires a bit rate of X divided by the number of transmitters, N. This is particularly useful where the bandwidth of the transmitter limits the performance of the system. The approach increases the bitrate of the system N-fold, where N is the number of transmitters, up to the limit of the rest of the system. As such, slower transmitters having a lower transmitter design complexity can be used in the system to provide the same bit rate. Further, complex electrical domain processes are not required to achieve the increased bit rate of the system of FIG. 1 and an increase in the number of propagation media (e.g., fiber cores) and photoreceivers is also not required.

According to some examples, each of transmitters 105a, 105b and 105c may be similar. Each transmitter of the system may have a similar design. Each transmitter of the system may have the same UI. In some examples, the transmitters may be different, but set up to have the same UI.

The offset delays between each data stream allow the data streams to be decoded at the receiver side. Receiver 109 or decoder 111a can use information of delay 103a to determine that decoder 111a should be used to decode the multiplexed data stream from transmitters 105a, 105b and 105c in order to provide decoded data stream 101a. Receiver 109 or decoder 111b can use information of delay 103b to determine that decoder 111b should be used to decode the multiplexed data stream from transmitters 105a, 105b and 105c in order to provide decoded data stream 101b. Receiver 109 or decoder 111c can use information of delay 103c to determine that decoder 111c should be used to decode the multiplexed data stream from transmitters 105a, 105b and 105c in order to provide decoded data stream 101c.

It should be noted that the decoded data streams 101a, 101b and 101c shown on the right-hand side of FIG. 1 correspond to the data streams 101a, 01b and 101c shown on the left-hand side of FIG. 1, although the decoded data streams may also include noise etc. introduced by at least one of the transmitting process, the receiving process, the decoding process.

If a delay was not used, the output signal would be indistinguishable from a multi-level format, operating at double the original bitrate. It would not be possible to distinguish the ‘10’ and ‘01’ in a 2-transmitter system, or the ‘100’, ‘010’, and ‘001’ in a 3-transmitter system.

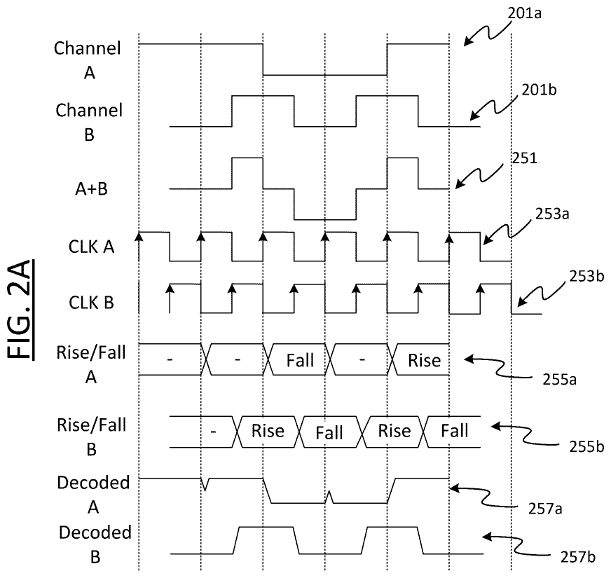

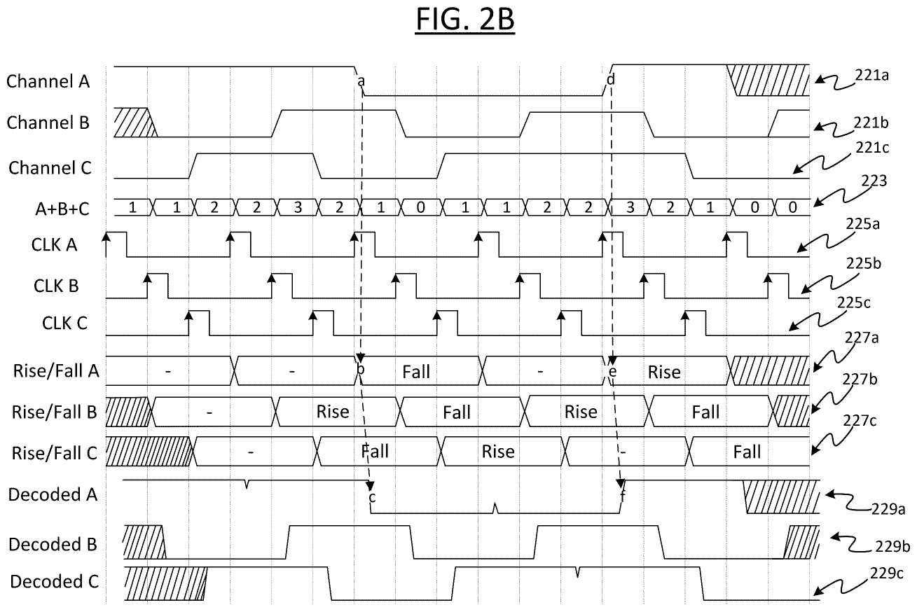

An example scenario with a 2-transmitter system is shown in FIG. 2A. Channel A 201a from a first transmitter has a bit pattern 11001, channel B 201b from a second transmitter has a bit pattern 01010, where each bit takes one unit interval and each vertical dotted line a unit interval.Channel B 201b is UI/2 delayed relative to Channel A 201a, as shown in FIG. 2A. In the example of FIG. 2A, N=2. Each of channels A 201a and B 221b may have the same UI. This can be achieved, for example, by synchronizing the transmitters of each channel accordingly.

The output of A+B is multiplexed into the same optical medium (e.g., optical medium 107 of FIG. 1), forming A+B 251 as shown in the third row of FIG. 2A. Then, the transition of whether A+B 251 is rising or falling is detected at the clock impulse CLK A 253a and CLK B 253b. This can be performed using a decoder for each channel comprising a rising edge detector circuit and a falling edge detector circuit. CLK A 253a and CLK B 253b are also offset relative to one another by UI/2. Using the detection of the transition of where A+B 251 is falling or rising combined with the synchronised clock signals 253a and 253b result in Rise/Fall A 255a and Rise/Fall B 255b. The clock, along with a simple state machine (e.g., a D-flip flop) allows the data to be decoded, shown in Decoded A 257a and Decoded B 257b. The kink in 257a and 257b is illustrative to show the difference between each decoded data.

An example scenario with a 3-transmitter system is shown in FIG. 2B. Channel A 221a from a first transmitter (e.g., transmitter 101a) has a bit pattern 11001, channel B 221b from a second transmitter (e.g., transmitter 101b) has a bit pattern 01010 and channel C 221c from a third transmitter (e.g., transmitter 101c) has a bit pattern 10110. Each of channels A 221a, B 221b, C 221c may be offset from one another by UI/3. In this example, N=3, and each vertical dotted line is a third of a unit interval (UI/3).

Each of channels A 221a, B 221b, C 221c may have the same UI. This can be achieved, for example, by synchronizing the transmitters of each channel accordingly.

The output of A+B+C is multiplexed into the same optical medium (e.g. optical medium 107), forming A+B+C 223. Then, the transition of whether A+B+C 223 is rising or falling is detected at the clock impulses CLK A 225a, CLK B 225b and CLK C 225c. This can be performed using a decoder for each channel comprising a rising edge detector circuit and a falling edge detector circuit. CLK A 225a, CLK B 225b and CLK C 225c are also offset relative to one another by UI/3. The detection of the transition of whether A+B+C 223 is falling or rising detected at the clock signals 253a, 253b and 253c results in Rise/Fall A 227a, Rise/Fall B 227b and Rise/Fall C 227c. The clock, along with a simple state machine (e.g., a D-flip flop) allows the data to be decoded, shown in Decoded A 229a, Decoded B 229b and Decoded C 229c. As shown in FIG. 2B, the kink is used to separate adjacent bits of the same value (‘11’ and ‘00’) for illustration purposes.

FIG. 2B shows how a transition from 1 to 0 in Channel A 221a at point a is mapped, using CLK signal A 225a, to a Fall at point b in the Rise/Fall detection 227a for channel A. This is also mapped to point c in decoded signal A 229a.

FIG. 2B also shows how a transition from 0 to 1 in Channel A 221a at point d is mapped, using CLK signal A 225a, to a Rise at point b in the Rise/Fall detection 227a for channel A. This is also mapped to point f in decoded signal A 229a.

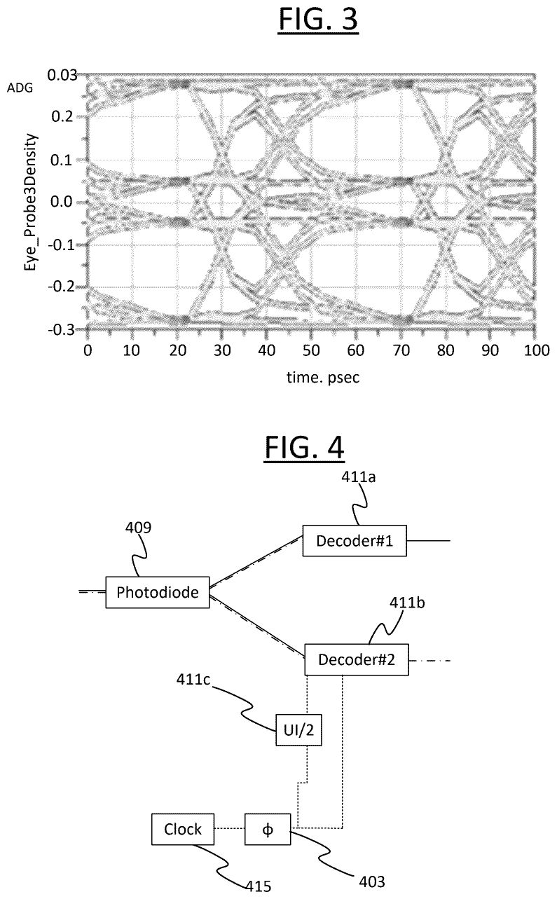

FIG. 3 shows an example eye diagram for the multiplexed channel (channel A+channel B) of FIG. 2A.

The multiplexed data can be decoded using known rising edge/falling edge detectors. The detectors may be separately clocked. The detectors can be used to reconstruct the individual data streams at the receiver side.

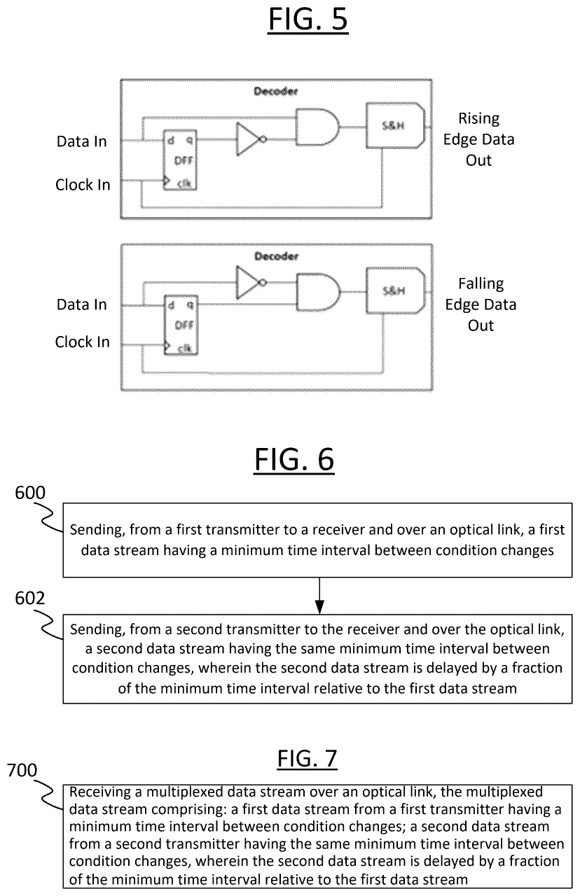

FIG. 4 shows a schematic block diagram of a system that could be used for decoding the multiplexed data streams of FIGS. 1 to 3 at the receiver side. In this example the receiver is photodiode 409, but other suitable receivers may be used. A clock 415 provides a clock impulse to decoders 411a and 411b. Information of the delay 403 between the data streams in the multiplexed data stream is provided at 411c (in this example, N=2, but other values of N may be used). An example circuit of a rising edge detector and a falling edge detector used at each of decoders 411a and 411b is shown in FIG. 5. Each decoder 411a and 411b may comprise a pair of edge detectors, one rising edge detector and one falling edge detector.

Synchronization between channels can be performed by sending, from at least one of the transmitters or from another device, a “code” or indication at the start time of data transmission to indicate the phase delay between each channel, and the identity of each channel. These frames can be sent at the start-up, or regularly, as required. The clocks can be generated at 415 to be fed into each decoder 411a and 411b. In this example decoder 411a decodes the channel represented by a solid line and decoder 411b decodes the channel represented by a dash-dot line.

For many transmitters, where the sequencing is known (for example, Channel A, B, C, D, E . . . ) shift registers can be utilized at the detection side. Since the channels follow a known sequence, the frames in addition with shift registers on the receiver decoders side, the corresponding receiver channels (A to E . . . ) can be identified. The channels can then be decoded, with each channel being decoded by a respective decoder.

FIG. 5 shows a circuit diagram of an example rising edge detector and an example falling edge detector. It should be noted that the examples described herein may use other suitable circuits for detecting rise and fall in a data channel.

FIG. 6 illustrates a method of transmitting data.

At 600, the method comprises sending, from a first transmitter and to a receiver and over an optical link, a first data stream having a minimum time interval between condition changes.

At 602, the method comprises sending, from a second transmitter to the receiver and over the optical link, a second data stream having the same minimum time interval between condition changes, wherein the second data stream is delayed by a fraction of the minimum time interval relative to the first data stream.

FIG. 7 illustrates a method of receiving data.

At 700, the method comprises receiving a multiplexed data stream over an optical link, the multiplexed data stream comprising: a first data stream from a first transmitter having a minimum time interval between condition changes; a second data stream from a second transmitter having the same minimum time interval between condition changes, wherein the second data stream is delayed by a fraction of the minimum time interval relative to the first data stream sending, from a first transmitter and to a receiver and over an optical link, a first data stream having a minimum time interval between condition changes.

All of the disclosed operations or method steps, including those expressed in mathematical terms, may be implemented using suitable machine logic steps.

### Closing Remarks

It will be appreciated that the above embodiments have been disclosed by way of example only.

More generally, according to one aspect disclosed herein, there is provided an apparatus for receiving data, wherein the apparatus is configured to: receive a multiplexed data stream over an optical link, the multiplexed data stream comprising: a first data stream sent from a first transmitter, the first data stream having a minimum time interval between condition changes; a second data stream sent from a second transmitter, the second data stream having the same minimum time interval between condition changes, wherein the second data stream is delayed by a fraction of the minimum time interval relative to the first data stream.

According to some examples, the minimum time interval comprises a unit interval.

According to some examples, the multiplexed data stream comprises: a third data stream sent from a third transmitter having the same minimum time interval between condition changes, wherein the third data stream is delayed by a second fraction of the minimum time interval relative to the first data stream, wherein the second fraction is a multiple of the fraction of the minimum time interval.

According to some examples, the apparatus is configured to: receive, from the transmitter or from another device, an indication of the delay of each data stream.

According to some examples, the apparatus is configured to: decode the data received over the optical link using a shift register and the indication of the delay of each data stream.

According to some examples, the apparatus comprises: a first decoder configured to decode the first data stream from the multiplexed data stream; a second decoder configured to decode the second data stream from the multiplexed data stream.

According to some examples, the first decoder comprises a first rising edge detector and a first falling edge detector and the second decoder comprises a second rising edge detector and a second falling edge detector.

According to some examples, first decoder is configured to use a first clock signal to determine if the first data stream is rising or falling, and the second decoder is configured to use a second clock signal to determine if the second data stream is rising or falling, wherein the second clock signal is offset by the fraction of the minimum time interval relative to the first clock signal.

According to another aspect disclosed herein, there is provided a method of receiving data comprising: receiving a multiplexed data stream over an optical link, the multiplexed data stream comprising: a first data stream from a first transmitter having a minimum time interval between condition changes; a second data stream from a second transmitter having the same minimum time interval between condition changes, wherein the second data stream is delayed by a fraction of the minimum time interval relative to the first data stream.

According to some examples, the minimum time interval comprises a unit interval.

According to some examples, the multiplexed data stream comprises: a third data stream from a third transmitter having the same minimum time interval between condition changes, wherein the third data stream is delayed by a second fraction of the minimum time interval relative to the first data stream, wherein the second fraction is a multiple of the fraction of the minimum time interval.

According to some examples, the method comprises: receiving, from the transmitter, an indication of the delay of each data stream.

According to some examples, the method comprises: decoding the data received over the optical link using a shift register and the indication of the delay of each data stream.

According to some examples, the method comprises: decoding the first data stream from the multiplexed data stream using a first decoder; decoding the second data stream from the multiplexed data stream using a second decoder.

According to some examples, the first decoder comprises a first rising edge detector and a first falling edge detector and the second decoder comprises a second rising edge detector and a second falling edge detector.

According to some examples, the method comprises: using, by the first decoder, a first clock signal to determine if the first data stream is rising or falling; using, by the second decoder, a second clock signal to determine if the second data stream is rising or falling, wherein the second clock signal is offset by the fraction of the minimum time interval relative to the first clock signal.

According to another aspect disclosed herein, there is provided a receiver comprising a receiving interface configured to: receive a multiplexed data stream over an optical link, the multiplexed data stream comprising: a first data stream from a first transmitter having a minimum time interval between condition changes; a second data stream from a second transmitter having the same minimum time interval between condition changes, wherein the second data stream is delayed by a fraction of the minimum time interval relative to the first data stream.

According to another aspect disclosed herein, there is provided a non-transitory computer-readable storage comprising a program configured so as when run on one or more processors to perform the method of receiving data.

According to another aspect disclosed herein, there is provided a receiver comprising: memory comprising one or more memory devices, processing apparatus comprising one or more processors, and a receiving interface for receiving data over a network; wherein the memory stores code software arranged to run on the processing apparatus, and configured so as when run on the processing apparatus to perform the method of any of receiving data.

According to another aspect disclosed herein, there is provided a method of data transmission comprising: sending, from a first transmitter and to a receiver and over an optical link, a first data stream having a minimum time interval between condition changes; sending, from a second transmitter to the receiver and over the optical link, a second data stream having the same minimum time interval between condition changes, wherein the second data stream is delayed by a fraction of the minimum time interval relative to the first data stream.

According to some examples, the minimum time interval comprises a unit interval.

According to some examples, the method comprises: sending, from a third transmitter to the receiver and over the optical link, a third data stream having the same minimum time interval between condition changes, wherein the third data stream is delayed by a second fraction of the minimum time interval relative to the first data stream, wherein the second fraction is a multiple of the fraction of the minimum time interval.

According to some examples, the method comprises: sending, to the receiver, an indication of the delay of each data stream.

According to another aspect disclosed herein, there is provided a transmitter comprising a transmission interface configured to: send, from a first transmitter to a receiver and over an optical link, a first data stream having a minimum time interval between condition changes; send, from a second transmitter to the receiver and over the optical link, a second data stream having the same minimum time interval between condition changes, wherein the second data stream is delayed by a fraction of the minimum time interval relative to the first data stream.

According to another aspect disclosed herein, there is provided an apparatus for transmitting data, wherein the apparatus is configured to: send, over an optical link and from a first transmitter and to a receiver, a first data stream having a minimum time interval between condition changes; send, over the optical link from a second transmitter to the receiver, a second data stream having the same minimum time interval between condition changes, wherein the second data stream is delayed by a fraction of the minimum time interval relative to the first data stream.

According to some examples, the minimum time interval comprises a unit interval.

According to some examples, the apparatus is configured to: send, over the optical link from a third transmitter to the receiver, a third data stream having the same minimum time interval between condition changes, wherein the third data stream is delayed by a second fraction of the minimum time interval relative to the first data stream, wherein the second fraction is a multiple of the fraction of the minimum time interval.

According to some examples, the apparatus is configured to: send, to the receiver, an indication of the delay of each data stream.

According to another aspect disclosed herein, there is provided non-transitory computer-readable storage comprising a program configured so as when run on one or more processors to perform the method of transmission.

According to another aspect disclosed herein, there is provided a transmitter comprising: memory comprising one or more memory devices, processing apparatus comprising one or more processors, and a transmitting interface for transmitting over a network; wherein the memory stores code software arranged to run on the processing apparatus, and configured so as when run on the processing apparatus to perform the method of transmission.

Other variants or use cases may become apparent to a person skilled in the art once given the disclosure herein. The scope of the present disclosure is not limited by the above-described embodiments, but only by the accompanying claims.

1. An apparatus for receiving data, wherein the apparatus is configured to:
receive a multiplexed data stream over an optical link, the multiplexed data stream comprising:
a first data stream sent from a first transmitter, the first data stream having a minimum time interval between condition changes;
a second data stream sent from a second transmitter, the second data stream having the same minimum time interval between condition changes, wherein the second data stream is delayed by a fraction of the minimum time interval relative to the first data stream.

2. The apparatus according to claim 1, wherein the minimum time interval comprises a unit interval.

3. The apparatus according to claim 1, wherein the multiplexed data stream comprises:
a third data stream sent from a third transmitter having the same minimum time interval between condition changes, wherein the third data stream is delayed by a second fraction of the minimum time interval relative to the first data stream, wherein the second fraction is a multiple of the fraction of the minimum time interval.

4. The apparatus according to claim 1, wherein the apparatus is configured to:
receive, from the transmitter or from another device, an indication of the delay of each data stream.

5. The apparatus according to claim 4, wherein the apparatus is configured to:
decode the data received over the optical link using a shift register and the indication of the delay of each data stream.

6. The apparatus according to claim 1, wherein the apparatus comprises:
a first decoder configured to decode the first data stream from the multiplexed data stream;
a second decoder configured to decode the second data stream from the multiplexed data stream.

7. The apparatus according to claim 6, wherein the first decoder comprises a first rising edge detector and a first falling edge detector and the second decoder comprises a second rising edge detector and a second falling edge detector.

8. The apparatus according to claim 7, wherein the first decoder is configured to use a first clock signal to determine if the first data stream is rising or falling, and the second decoder is configured to use a second clock signal to determine if the second data stream is rising or falling, wherein the second clock signal is offset by the fraction of the minimum time interval relative to the first clock signal.

9. A method of receiving data comprising:
receiving a multiplexed data stream over an optical link, the multiplexed data stream comprising:
a first data stream from a first transmitter having a minimum time interval between condition changes;
a second data stream from a second transmitter having the same minimum time interval between condition changes, wherein the second data stream is delayed by a fraction of the minimum time interval relative to the first data stream.

10. The method according to claim 9, wherein the minimum time interval comprises a unit interval.

11. The method according to claim 9, wherein the multiplexed data stream comprises:
a third data stream from a third transmitter having the same minimum time interval between condition changes, wherein the third data stream is delayed by a second fraction of the minimum time interval relative to the first data stream, wherein the second fraction is a multiple of the fraction of the minimum time interval.

12. The method according to claim 9, wherein the method comprises:
receiving, from the transmitter, an indication of the delay of each data stream.

13. The method according to claim 12, wherein the method comprises:
decoding the data received over the optical link using a shift register and the indication of the delay of each data stream.

14. The method according to claim 9, wherein the method comprises:
decoding the first data stream from the multiplexed data stream using a first decoder;
decoding the second data stream from the multiplexed data stream using a second decoder.

15. The method according to claim 14, wherein the first decoder comprises a first rising edge detector and a first falling edge detector and the second decoder comprises a second rising edge detector and a second falling edge detector.

16. The method according to claim 15, comprising:
using, by the first decoder, a first clock signal to determine if the first data stream is rising or falling;
using, by the second decoder, a second clock signal to determine if the second data stream is rising or falling, wherein the second clock signal is offset by the fraction of the minimum time interval relative to the first clock signal.

17. An apparatus for transmitting data, wherein the apparatus is configured to:
send, over an optical link and from a first transmitter and to a receiver, a first data stream having a minimum time interval between condition changes;
send, over the optical link from a second transmitter to the receiver, a second data stream having the same minimum time interval between condition changes, wherein the second data stream is delayed by a fraction of the minimum time interval relative to the first data stream.

18. The apparatus according to claim 17, wherein the minimum time interval comprises a unit interval.

19. The apparatus according to claim 17, wherein the apparatus is configured to:
send, over the optical link from a third transmitter to the receiver, a third data stream having the same minimum time interval between condition changes, wherein the third data stream is delayed by a second fraction of the minimum time interval relative to the first data stream, wherein the second fraction is a multiple of the fraction of the minimum time interval.

20. The apparatus according to claim 17, wherein the apparatus is configured to:
send, to the receiver, an indication of the delay of each data stream.
